(19) United States
(12) Patent Application Publication
(10) Pub. No.: US 2022/0095556 A1
(43) Pub. Date: Mar. 31, 2022

(54) VERTICAL PLANTING APPARATUS

(71) Applicant: Darral Addison, Lansdale, PA (US)

(72) Inventor: Darral Addison, Lansdale, PA (US)

(21) Appl. No.: 17/547,725

(22) Filed: Dec. 10, 2021

Related U.S. Application Data
(63) Continuation of application No. 16/151,286, filed on Oct. 3, 2018, now abandoned.
(60) Provisional application No. 62/567,701, filed on Oct. 3, 2017.
(60) Provisional application No. 62/607,062, filed on Dec. 18, 2017.

(51) Int. Cl. A01G 25/02; A01G 9/24; A01G 25/16; A01G 9/02

(52) U.S. Cl. CPC A01G 25/02; A01G 9/247; A01G 9/0297; A01G 9/022; A01G 25/16

(57) ABSTRACT

A planting apparatus is disclosed. The planting apparatus includes: a main vertical member connectable to a planting pot, wherein the vertical member is cylindrical-shaped and includes a plurality of openings along a cylindrical-surface thereof. Embodiments of the planting apparatus include a planting pot having a base having conical frustum-shaped walls and a base surface, wherein the base includes interior annular walls for receiving an end of the main vertical member.

### CROSS REFERENCE TO RELATED APPLICATIONS

This application is a continuation application, claiming priority to U.S. application Ser. No. 16/151,286 filed Oct. 3, 2018, which claims the benefit of Provisional Application No. 62/567,701 filed on Oct. 3, 2017 and Provisional Application No. 62/607,062 filed on Dec. 18, 2017, all of which are hereby incorporated herein by reference.

### TECHNICAL FIELD

This disclosure relates to agriculture, and more particularly to plant selectively expandable planting systems.

### BACKGROUND

The statements in this section merely provide background information related to the present disclosure and may not constitute prior art.

Agricultural systems, including, hydroponic systems, are increasingly used for various plant growing operations. These systems are known to support conventional pots and planting structures. Various indoor plumbing systems have been adapted to spray or otherwise allow for a user to manually water the plants.

Known agricultural systems are disadvantaged in that they: (1) are not selectively assembled; (2) and do not allow for selective and dynamic placement of plants and plant holders; and (3) do not have internal watering systems that may be selectively connected.

Accordingly, a need exists for dynamic planting grid assembly having internal watering system.

### SUMMARY

A planting apparatus is disclosed. The planting apparatus includes: a main vertical member connectable to a planting pot, wherein the vertical member is cylindrical-shaped and includes a plurality of openings along a cylindrical-surface thereof. Embodiments of the planting apparatus include a planting pot having a base having conical frustum-shaped walls and a base surface, wherein the base includes interior annular walls for receiving an end of the main vertical member.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIGS. 1-4 shows various exemplary embodiments of an assembled plant holder, in accordance with the present disclosure;

FIG. 5 shows an exemplary unassembled plant holder, in accordance with the present disclosure;

FIG. 6 shows an exemplary clamp, in accordance with the present disclosure;

FIG. 7 shows an exemplary embodiment of the plant holder having an internal watering system, in accordance with the present disclosure;

FIG. 8 is a view of the plant holder without the pot and portion of a vertical member, in accordance with the present disclosure;

FIGS. 9-11 show a pot support assembly and vertical support member of the plant holder, in accordance with the present disclosure; and

FIG. 12 is an enlarged view of an exemplary opening;

FIG. 13 schematically shows an exemplary watering system, in accordance with the present disclosure;

FIG. 14 is a cross-sectional view of a vertical member, in accordance with the present disclosure;

FIG. 15 shows an exemplary grid system, in accordance with the present disclosure;

FIG. 16 shows the grid system in a partially unassembled state, in accordance with the present disclosure;

FIG. 17 shows another exemplary grid system, in accordance with the present disclosure;

FIG. 18 is a top plan view of the grid system shown in FIG. 17, in accordance with the present disclosure;

FIG. 19 shows an exemplary grid section, in accordance with the present disclosure;

FIGS. 20A-20D show an exemplary base of a vertical member, in accordance with the present disclosure;

FIG. 21 shows an exemplary bird feeder that may be connected to the grid system, in accordance with the present disclosure; and

FIG. 22 is a cross-sectional view of the bird feeder, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

As used herein, the phrase “at least one of”, when used with a list of items, means different combinations of one or more of the listed items may be used and only one of the items in the list may be needed. The item may be a particular object, thing, or category. In other words, “at least one of means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

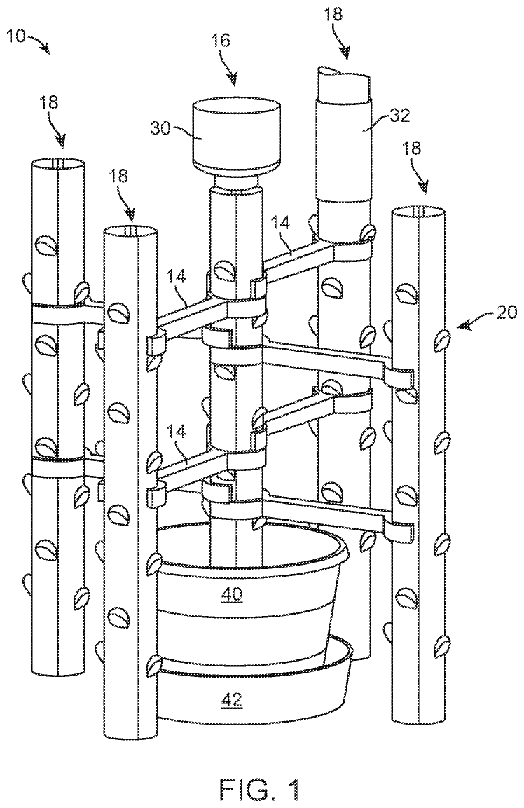

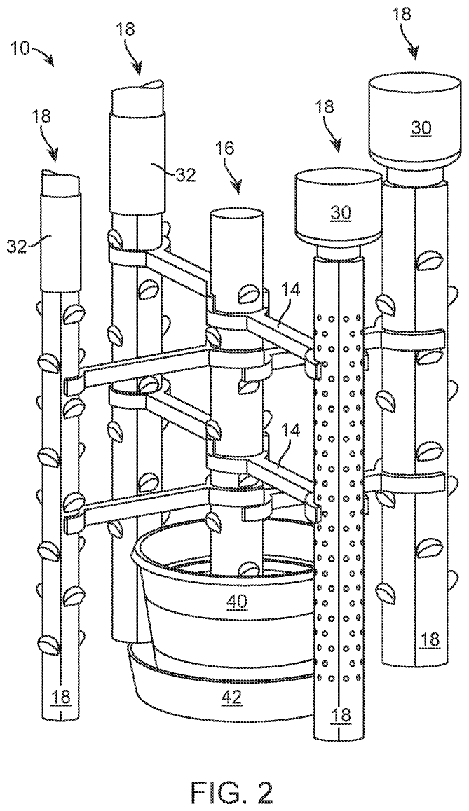

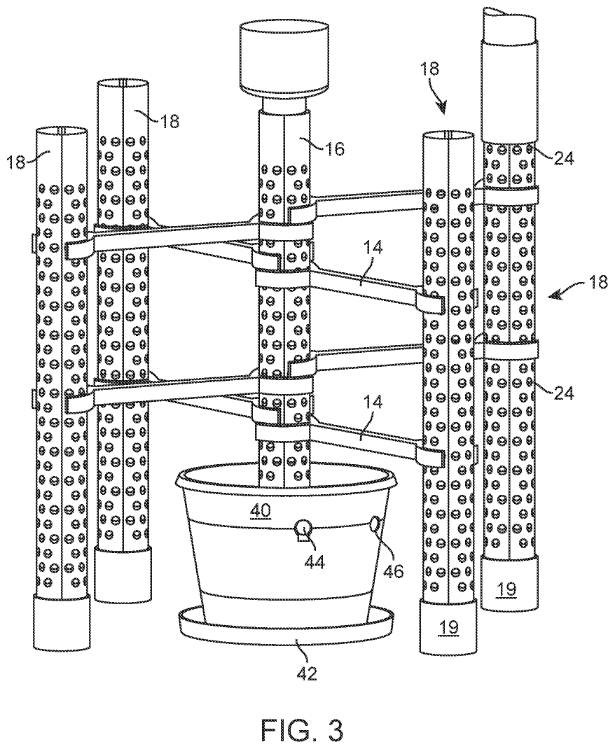

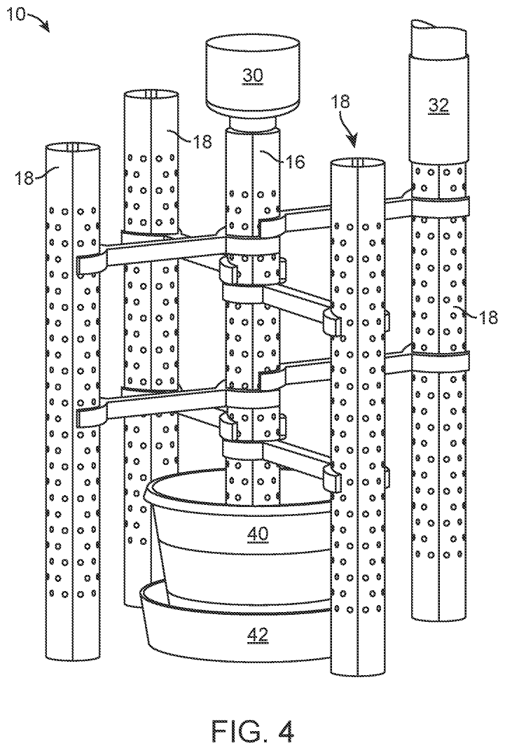

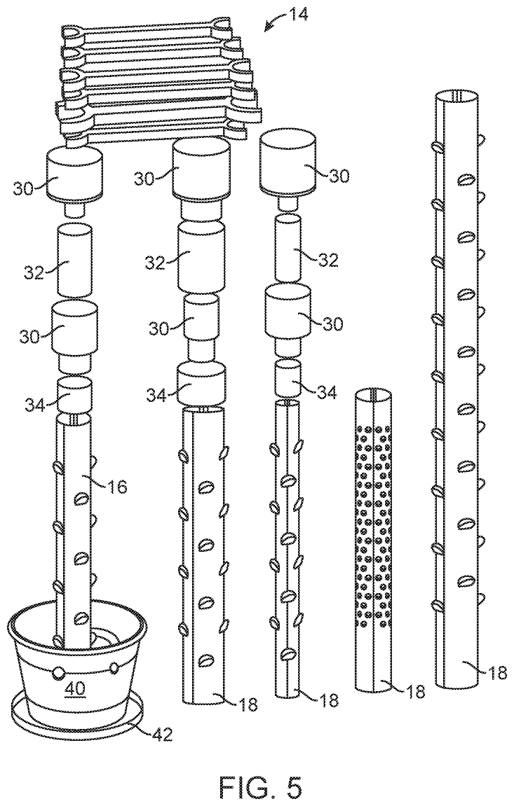

Referring now to the drawings, wherein the depictions are for the purpose of illustrating certain exemplary embodiments only and not for the purpose of limiting the same, FIGS. 1-4 show various embodiments of assembled plant holders 10 of the present disclosure. The plant holder 10 includes a main vertical member 16, one or more supplementary vertical members 18, a plurality of clamps 14, and a pot and vertical member support 40. A basin 42 may be included. In various embodiments, one or more spouts 30 may be attached to a vertical member 16 or 18. In one embodiment, an adapter 32 is attached to a vertical member 16 or 18, so that an additional vertical member 16 or 18 may be attached within the adapter 32, thereby extending a vertical reach of the member.

In one embodiment, the clamps 14 include a hallow channel for fluid communication of water between vertical members such as member 16 and members 18. The clamps 14 may be fluidly connected to an outlet on the main member 16 and an inlet on the member 18, for example.

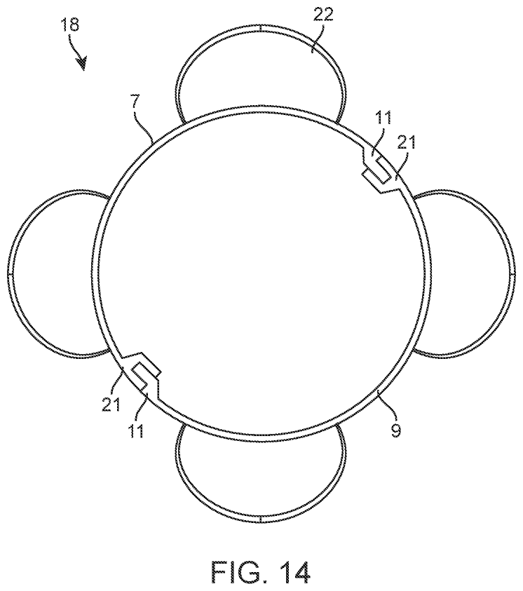

The supplemental vertical members 18 are cylindrical-shaped preferably having a bottom cap 19. The vertical members 18 may be integrally formed or formed from one or more components. For example, in one embodiment, the cylindrical-shaped member 18 is integrally formed and the end cap 19 is press fit around an outside surface. In one embodiment, the vertical members 16 and 18 are formed of a first and second half-cylindrical portions, 7 and 9, respectively, which are friction fit together using an elongated tongue 11 and groove 21 such as shown in FIG. 14. In this way, the halves of the members 16 and 18 may be separated for harvesting roots. Preferably, the vertical members 16 and 18 have a circular cross-sectional shape, however, most any cross-sectional shape may be implemented.

Each vertical member 18 may include a spout 30 for receiving and holding a plant or for receiving water. The vertical members 18 may receive an adapter 32 and then another vertical member 18, thereby extending a vertical height that the plant holder 10 may reach. The vertical members 16 and 18 must be sized and adapted to support a plant, an internal hose, compost, soil or other planting material, and water. The vertical members 16 and 18 can be filled with composting materials, slow release fertilizers, or worms to aid in decomposition.

As shown in FIGS. 1-4, four vertical members 18 may be included on the plant holder 10. However, as one skilled in the art will readily recognize, any number of vertical member 18 may be included. Further, the vertical members 18 may vary in diameter, height, quantity of openings 20, and type of openings with respect to one another.

The vertical members 18 are preferably attached to the main vertical member 16 via one or more clamps 14. As shown in the figures, two clamps are used with adequate spacing between clamps on the members 16 and 18. The clamps 14 are press-fit onto the members 16 and 18. In one embodiment, the clamps 14 are formed with a slightly smaller opening than a diameter of the members 16 and 18. In this way, the clamps 14 may be urged to clasp the members and then urged or pulled off when desired.

Components of the plant holder 10 are preferably plastic, plastic-polymer-based, and/or resin, however, one or more of any known material sufficient in strength and durability and will suffice. The material is preferably ridged or semi-ridged.

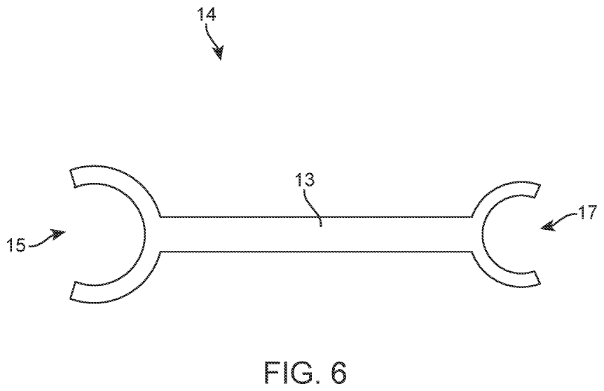

FIG. 6 shows an exemplary clamp 14. As FIG. 6 shows, the clamps 14 may be formed to have a first and second clasping ends 15 and 17, respectively. The clasping ends 15 and 17 are preferably joined by an elongated member 13. The clamps 14 are preferably integrally formed. The opening size of the clasping ends 15 and 17 may be different, such as shown in FIG. 6, or may have a same size.

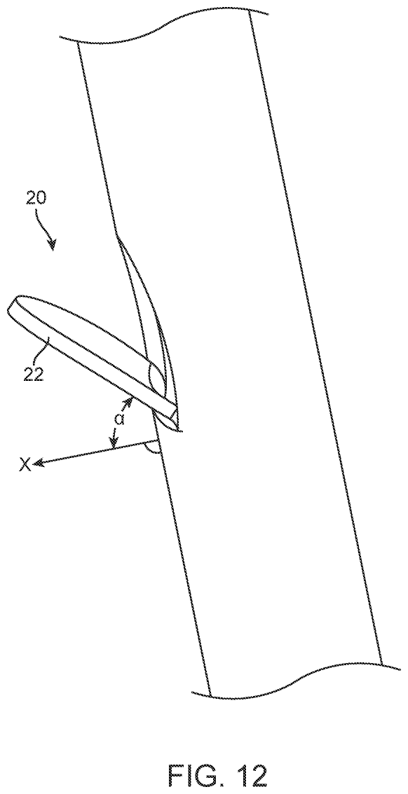

FIG. 12 shows an opening 20 that may be included on the vertical members 16 and 18. As FIG. 12 shows, the opening 20 includes a flap 22. The flap 22 may be a cut-out of the member 16 or 18 and may function to provide support for plant stalks or limbs. The opening 20 may be sized and adapted for various plant types. For example, heavier plants may require a larger opening. In various embodiments, the flap 22 may simply be removed, thereby leaving an opening without support.

As FIG. 12 shows, the opening 20 may be angled. In one embodiment, the opening is 40-degrees. In one embodiment, the opening is 25-degrees. In one embodiment, the flap 22 is angled at 25-degrees. In one embodiment, the opening 20 is preferably formed in a range of 25 to 60 degrees. In one embodiment, the flap is formed in a range of 25 to 60 degrees. Angled openings minimize water escape from the members 16 and 18. The flap 22 assists in directing exterior water to the plant, such as from rain. The openings 20 also aid in soil aeration. In one embodiment, the openings 20 are spaced apart for a desired plant to soil ratio.

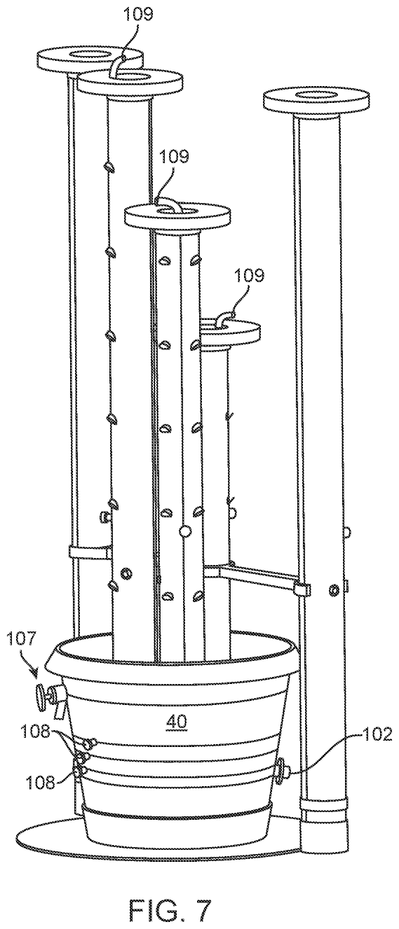

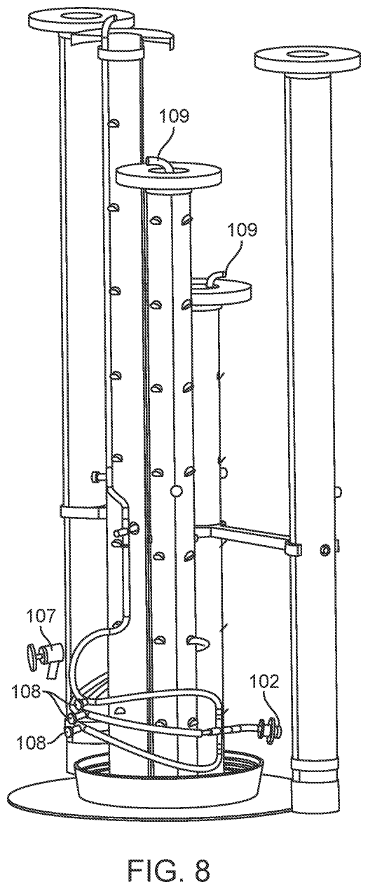

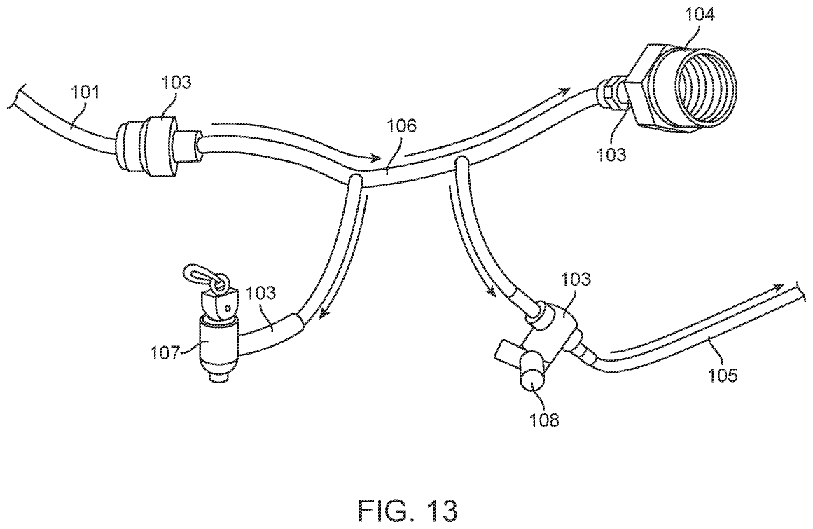

FIG. 13 schematically shows an exemplary watering system 100 that may be used within the plant holder 10 such as illustrated in FIGS. 7 and 8. As FIG. 13 shows, the watering system 100 includes a male connector 102 for connection to a garden hose 101. The male connector 102 is attached or connected to a hose 106. The hose 106 may be attached to any number of watering components including a spout and valve 107 for selective water exit, a plurality of valves 108, and a female connector 104. The watering system 100 may include a filter. In one embodiment, the male connector 102 includes a filter to prevent debris from entering the system 100.

In one embodiment, the hose is porous. In one embodiment, the hose 106 comprises sections within the vertical members 16 and 18 that are semi-porous. In one embodiment, the hose 106 is capped at an end 109. In one embodiment, one or more of the caps 109 include a spray end configured to spray out an amount of water to an exterior of the vertical members. In one embodiment, each vertical member 16 and 18 includes a hose section traversing from one of the valves 107. In this way, water flow to each of the vertical members may be selectively controlled.

The hose 106 and/or hose sections may be adhered or connected to inner walls of the vertical members 16 and 18. In one embodiment, portions of the hose 106 are connected to a top portion of the members 16 and 18, thereby supporting positioning of hose sections within the vertical members 16 and 18.

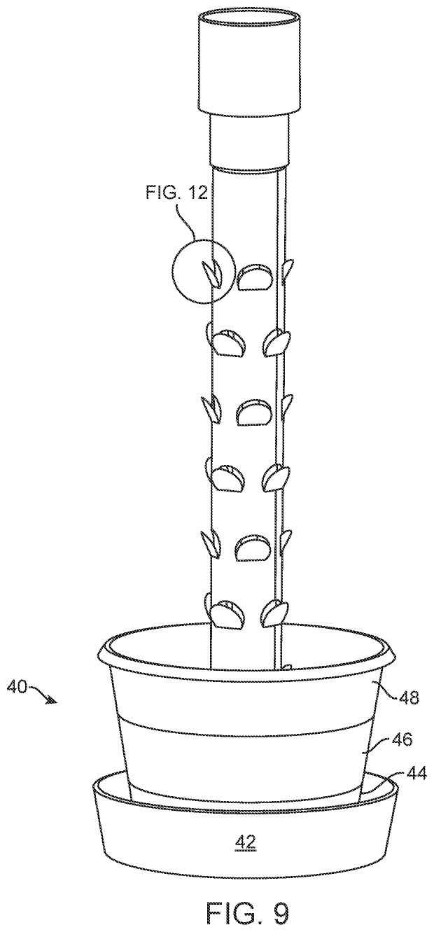

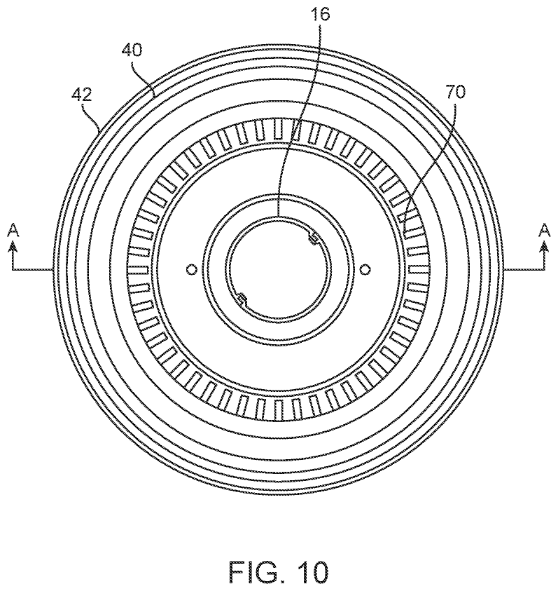

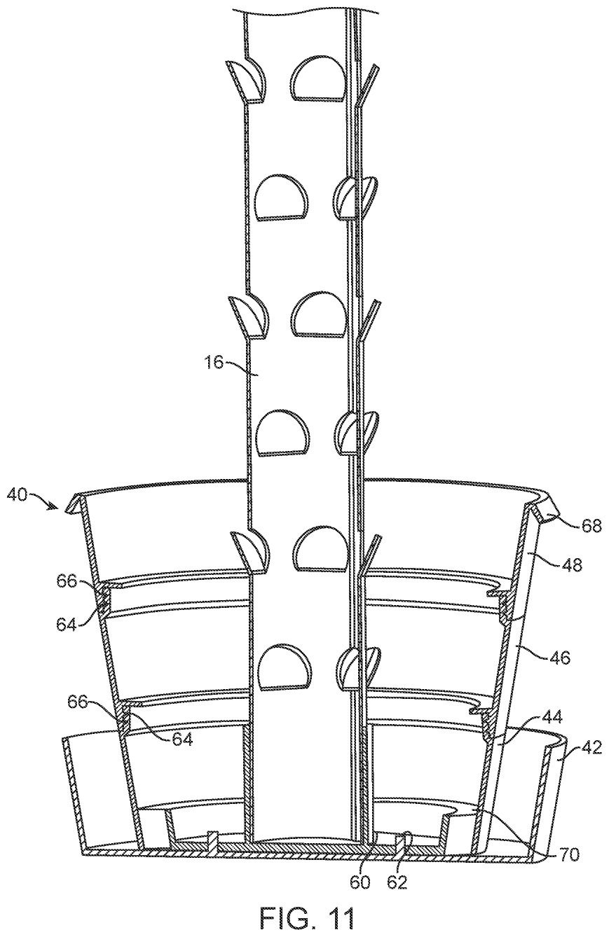

FIGS. 9-11 are shown to illustrate the exemplary pot structure 40. FIG. 11 is a cross-sectional view along line A-A of FIG. 10. As FIGS. 9-11 show, the pot structure 40 comprises a first ring 44, a second ring 46 and a third ring 48. The first ring 44 includes a cap 60 having annular walls for receiving an end of the vertical member 16. A diameter of an inner annular wall of the cap 60 is substantially the same diameter as the vertical member 16. In one embodiment, the diameter of the inner annular wall of the cap 60 is slightly smaller than the diameter of the vertical member 16. In this way, the vertical member 16 is rigidly received in the cap 60 and sway movement is minimized.

The basin 42, in one embodiment, includes pegs 62 sized and configured for pass though into the first ring 42. In this way, the first ring 44 is rigidly secured and water-tight. The second ring 46 is press-fit into the first ring 44. In one embodiment, the first and second rings include corresponding teeth 64 and grooves 66 for press-fit. Similarly, the third ring 48 is press-fit into the second ring 46 using corresponding teeth 64 and grooves 66. The third ring 48 may include an annular, angled flange 68. The basin 42 is preferably sized and configured to add stability to the plant holder 10.

In one embodiment, the first ring 44 includes a plurality of teeth 70, which aid in support and water displacement.

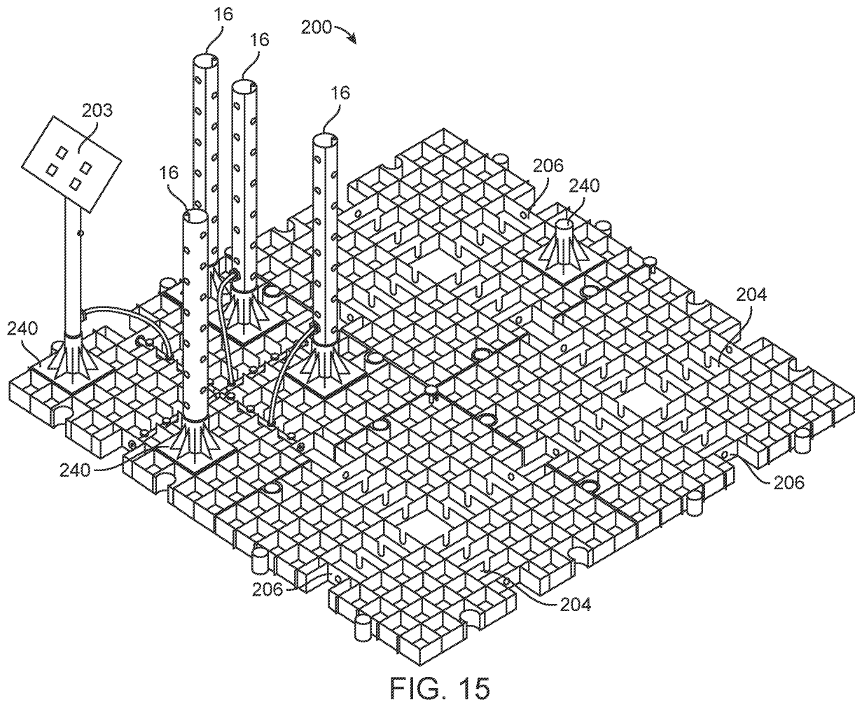

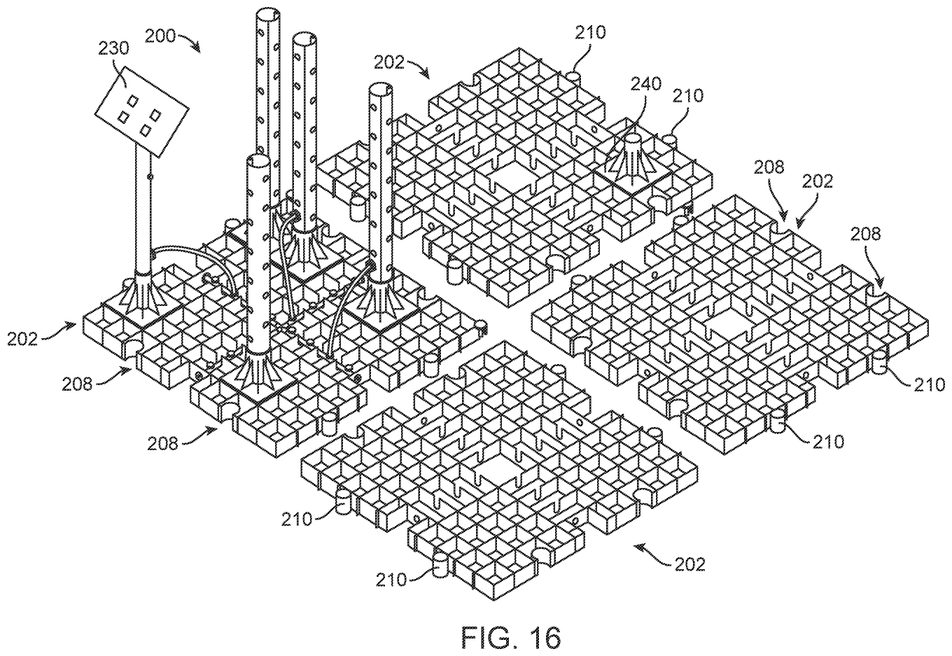

FIGS. 15 and 16 show an exemplary grid system 200 for holding one or more vertical members such as members 16 and 18 described hereinabove. The grid system 200 includes a plurality of grid sections 202 that are selectively connectable to other grids. As shown in FIGS. 15 and 16, the grid system 200 includes four grid sections 202, however, it is contemplated herein that various numbers of grids 202 may be used in any particular application to form a connected system 200.

A console 230 may be included into the grid system 200. The console can include a display screen for providing information to a user about operation of the system 200 including measurements from one or more sensors. The sensors can be placed throughout the system 200 including, e.g., within the water pipes 250, within one or more of the vertical members 16, such as within the hose 106 of the vertical members 16. One or more of a soil pH, phosphorus, potassium (k), organic matter, conductivity, and/or total dissolved solids may be measured and displayed on the console 230. In one embodiment, a hose 251 is attached to the console 230 from the manifold 250. Water flows through the hose 251, which is then monitored for any one of the abovementioned measurements.

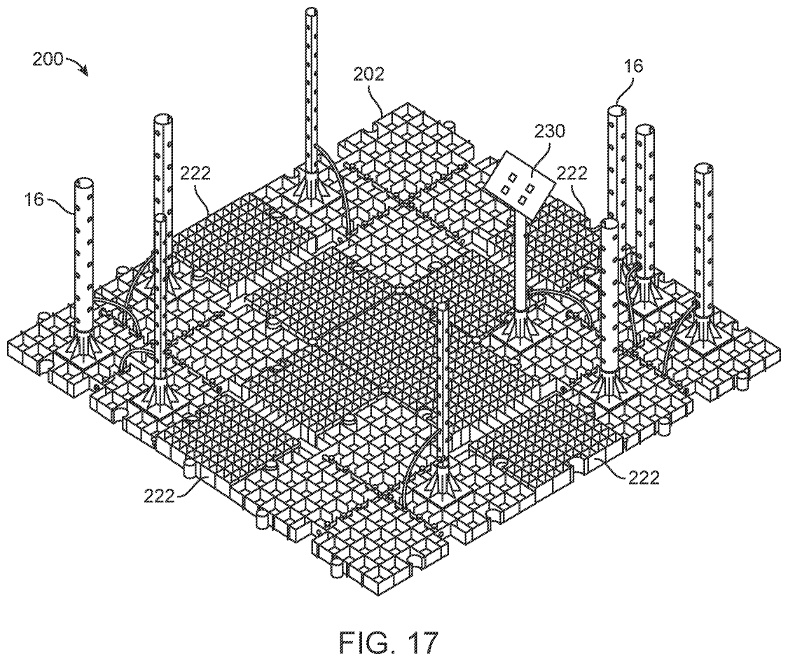

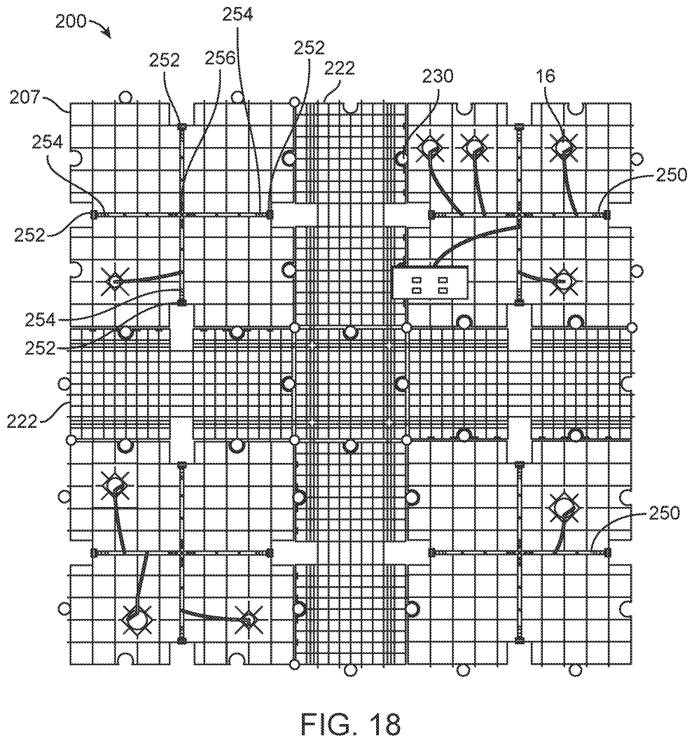

FIGS. 17 and 18 show another exemplary grid system 200 illustrating various grid types and arrangements of the plant holding vertical members 16. As FIGS. 17 and 18 show, a grid system 200 may include various types of grid sections. The first grid type 202 is also shown in FIGS. 15 and 16. The second grid type 222 is attached to the grids 202 in the manner described hereinabove. The grids 222 are formed of smaller square-shaped apertures. In this way, the grids 222 are able to hold more weight, which can be helpful when arranging this grid type as walkways or workspace within the system 200. The grid sections 222 may include U-shaped supports or supports with apertures for receiving and supporting water pipes.

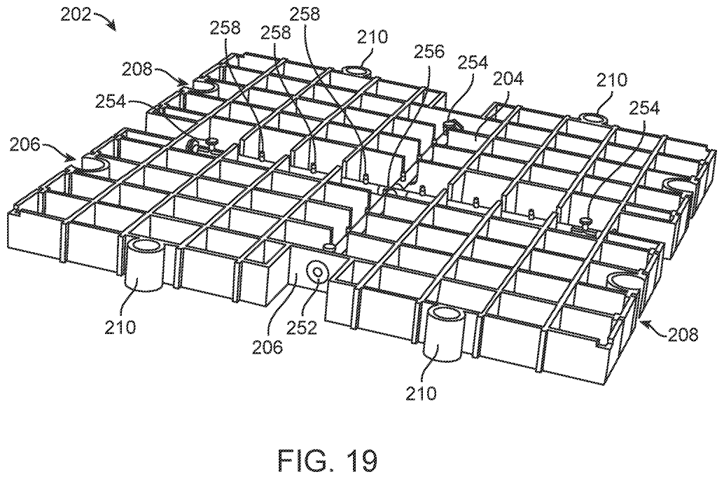

FIG. 19 shows an individual exemplary grid section 202. As FIG. 19 shows, each grid section 202 preferably includes a plurality of square-shaped apertures configured to receive and support various components including, e.g., a number of vertical member support bases 240, which may be arranged at many desired locations on the grids 202. The grids 202 include a plurality of U-shaped supports 204 for receiving and supporting water pipes. In one embodiment, various supports 206 are included having an aperture for receiving the water pipes, the aperture in-line with the U-shaped openings of the supports 204. While the figures show a square-shaped pattern defining a plurality of square-shaped grid openings, the grids 202 may be formed of any one of a number of non-square shaped patterns, e.g., a triangle-shaped, a rhombic, a pentagonal-shaped, a hexagonal-shaped, or octagonal-shaped, etc.

Each grid section 202 includes a plurality of socket-forming recesses 208 and a plurality of protruding portions 210. The protruding portion 210 is sized and adapted for substantially fitting into the recess 208 of another grid. In this way, each grid 202 may be selectively attached to another grid to create a working grid system 200. Preferably, each grid 202 includes a plurality of the protruding portions 210 and a plurality of the recesses 208. The recesses 208 are preferably formed on each side of a grid 202, while the protruding portions 210 are formed on adjacent sides of the sides having the recesses 208. In one embodiment, the protruding portions 210 are cylindrical in shape. In one embodiment, the recesses 208 are correspondingly cylindrical in shape, with a circumferential gap that is less than half the circumference. In this way, the protruding portion 210 must be laterally inserted into the recess 208, i.e., inserted from above or below a top surface of the grid 202.

The grids 202 and 222 are preferably injection molded of a suitable structural plastic material. The plastic material may also be reinforced with minerals, fibrous materials (e.g., glass, ceramic, carbon or fibers), combinations thereof or the like. In another non-limiting example, the grids 202 may be formed of a metal or metal alloy. In one embodiment, the grids are formed of HDPE plastic.

As FIGS. 15-19 show, each grid 202 may include water pipes 250 for transporting water and nutrients to the vertical members 16 and the plant roots within. Each grid 202 preferably has its own internal manifold which can include the pipes 250, valves 254, and a connector 256. Water and nutrients enters and exits each grid section 202 through the four end ports 252 in the manifold. In one embodiment, the connector 256 attaches to the pipes 250 at a first end and a valve 254 at a second end. The valves 254 may be connected to ports 252 for connection to other grids and/or to a water supply. The valves 254 are preferably configured for selective adjustment of the water flow, which can include a shut-off state. The vertical members 16 may be attached to the water pipes 250 at most any point via a connector or port 258, which may be threaded or, in one embodiment, quick-connect components.

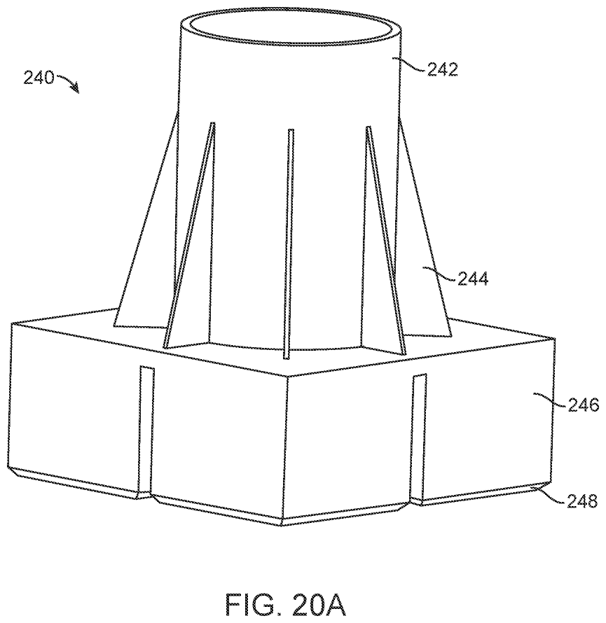

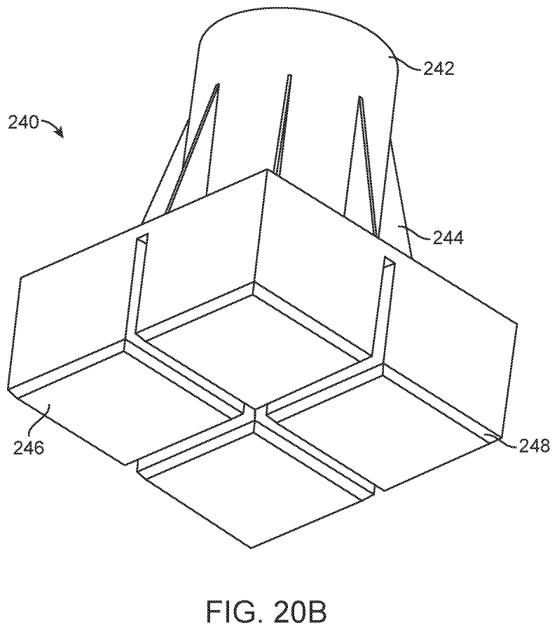

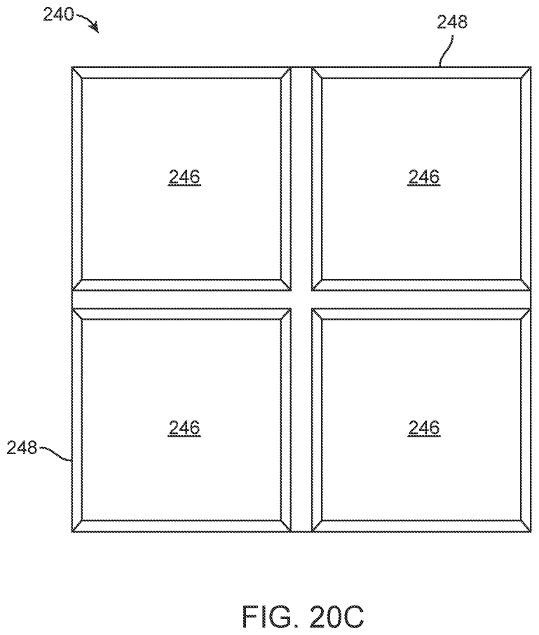

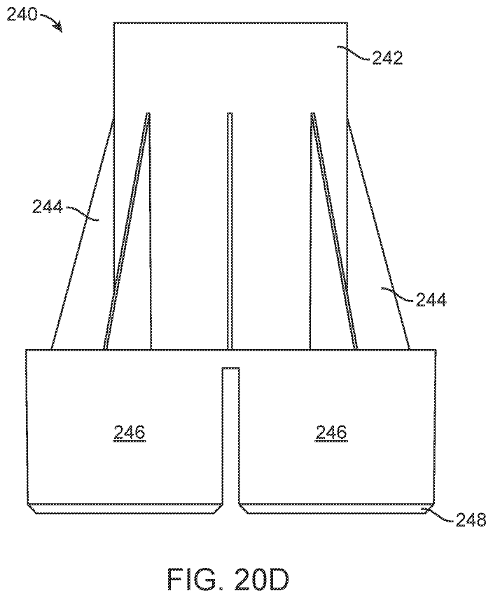

FIGS. 20A-20D, show a base 240 of a vertical member 16. The base includes one or more gussets 244 connected to a receiving cylinder 242, which has an inner diameter corresponding to an outer diameter of the vertical members 16 for a secure fit. The bottom portion of the base includes a plurality of fitting members 246, which are sized an adapted to fit within a grid opening of the grid section 202. The fitting members 246 may have tapered edges for ease of insertion into the square-shaped grid openings.

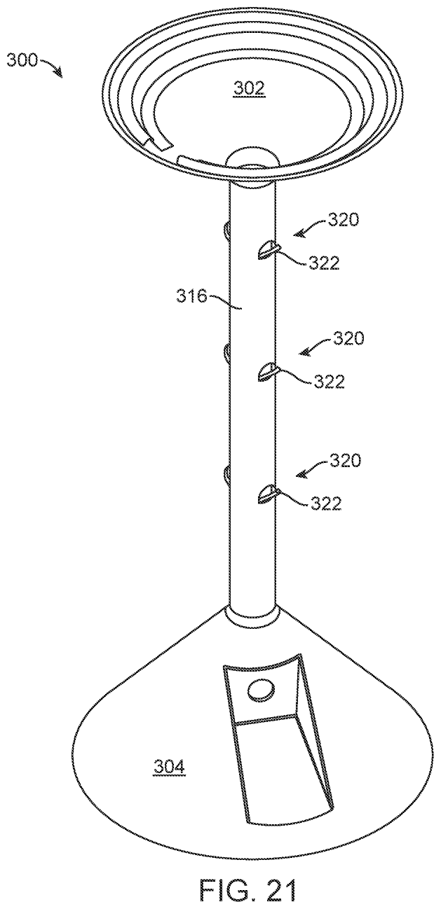

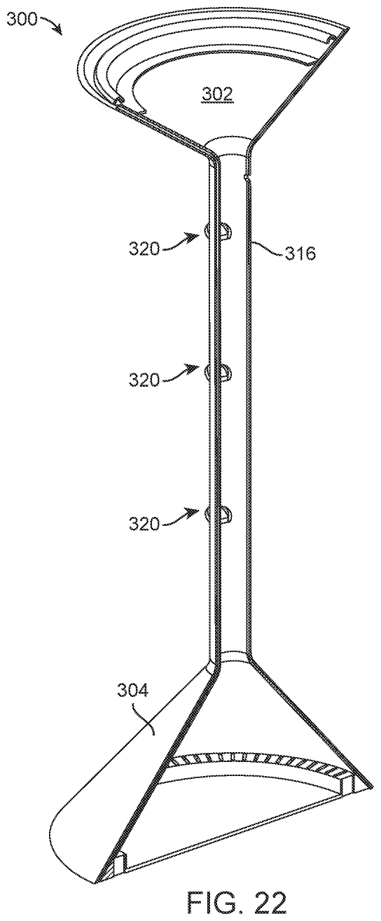

FIGS. 21 and 22 show an exemplary bird feeder 300 that may be connected to the grid system 200. As FIGS. 20 and 21 show, the bird feeders 300 may include a plurality of openings 320 for plants to grow out. The opening 320 may be angled as described hereinabove with respect to the openings 20 of the vertical members 16. The openings 320 may include a flap 322. The bird feeders 300 include a top portion 302 configured to hold water. A vertical member 316, which may be cylindrically-shaped.

The flap 322 may be a cut-out of the member 316 and may function to provide support for plant stalks or limbs. The opening 320 may be sized and adapted for various plant types. For example, heavier plants may require a larger opening. In various embodiments, the flap 322 may simply be removed, thereby leaving an opening without support. The bird feeder 300 preferably includes a base 304, which may be configured to: (1) attached to a grid 202; and (2) receive a hose for supplying water and nutrients to the plant roots within the vertical member 316.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A planting apparatus, comprising:
a main vertical member connectable to a planting pot, wherein the vertical member is cylindrical-shaped and includes a plurality of openings along a cylindrical-surface thereof.

2. The planting apparatus of claim 1, further comprising:
a plurality of supplementary vertical members, wherein each of the plurality of supplementary vertical members is removably connected to the main vertical member.

3. The planting apparatus of claim 2, wherein each of the plurality of supplementary vertical members is removably connected to the main vertical member using a clamp.

4. The planting apparatus of claim 3, wherein the clamps include a hallow channel for fluid communication of water between the main vertical member and the plurality of supplementary vertical members.

5. The planting apparatus of claim 4, wherein the clamps are fluidly connected to an outlet on the main vertical member and an inlet on the plurality of supplementary vertical members.

6. The planting apparatus of claim 1, wherein the plurality of openings are flaps.

7. The planting apparatus of claim 6, wherein the flaps are formed in a range of 25 to 60 degrees from the cylindrical-surface.

8. The planting apparatus of claim 2, wherein the supplementary vertical members include a plurality of openings including at least one flap formed in a range of 25 to 60 degrees from a cylindrical-surface thereof.

9. The planting apparatus of claim 1, wherein the planting pot comprises:
a base having conical frustum-shaped walls, wherein the base includes interior annular walls for receiving an end of the main vertical member and a base surface.

10. The planting apparatus of claim 9, wherein the planting pot further comprises:
a first conical frustum-shaped ring configured to attach to the conical frustum-shaped walls of the base; and
a second conical frustum-shaped ring configure to attach to the first ring.

11. The planting apparatus of claim 9, wherein the base and the first conical frustum-shaped ring include corresponding teeth and grooves for press-fit attachment.

12. The planting apparatus of claim 9, wherein the planting pot further comprises:
a basin having pegs configured to pass through the base surface of the base, wherein the basin has a diameter greater than the base.

13. The planting apparatus of claim 12, wherein the basin includes a plurality of teeth to aid in support and water displacement.

14. A planting apparatus, comprising:
a main vertical member, wherein the vertical member is cylindrical-shaped and includes a plurality of openings along a cylindrical-surface thereof; and
a planting pot having a base having conical frustum-shaped walls and a base surface, wherein the base includes interior annular walls for receiving an end of the main vertical member.

15. The planting apparatus of claim 14, wherein the planting pot further comprises:
a first conical frustum-shaped ring configured to attach to the conical frustum-shaped walls of the base; and
a second conical frustum-shaped ring configure to attach to the first ring.

16. The planting apparatus of claim 15, wherein the base and the first conical frustum-shaped ring include corresponding teeth and grooves for press-fit attachment, and wherein the first and second conical frustum-shaped rings include corresponding teeth and grooves for press-fit attachment.

17. The planting apparatus of claim 16, wherein the planting pot further comprises:
a basin having pegs configured to pass through the base surface of the base, wherein the basin has a diameter greater than the base.

18. The planting apparatus of claim 17, wherein the basin includes a plurality of teeth to aid in support and water displacement.

19. A planting apparatus, comprising:
a main vertical member, wherein the vertical member is cylindrical-shaped and includes a plurality of openings along a cylindrical-surface thereof, wherein the plurality of openings include at least one flap in a range of 25 to 60 degrees from the cylindrical-surface;
a planting pot having a base having conical frustum-shaped walls and a base surface, wherein the base includes interior annular walls for receiving an end of the main vertical member;
a plurality of supplementary vertical members, wherein each of the plurality of supplementary vertical members is removably connected to the main vertical member, wherein each of the plurality of supplementary vertical members is removably connected to the main vertical member using a clamp, wherein the clamps include a hallow channel for fluid communication of water between the main vertical member and the plurality of supplementary vertical members, wherein the clamps are fluidly connected to an outlet on the main vertical member and an inlet on the plurality of supplementary vertical members.

20. The planting apparatus of claim 19, wherein the planting pot further comprises:
a first conical frustum-shaped ring configured to attach to the conical frustum-shaped walls of the base; and
a second conical frustum-shaped ring configure to attach to the first ring;
a basin having pegs configured to pass through the base surface of the base, wherein the basin has a diameter greater than the base, wherein the basin includes a plurality of teeth to aid in support and water displacement; and
wherein the base and the first conical frustum-shaped ring include corresponding teeth and grooves for press-fit attachment, and wherein the first and second conical frustum-shaped rings include corresponding teeth and grooves for press-fit attachment.
